(19) United States
(12) Patent Application Publication
(10) Pub. No.: US 2012/0064214 A1
(43) Pub. Date: Mar. 15, 2012

(54) Avocado Cutting and Splitting Device

(76) Inventor: Richard Moore, Chula Vista, CA (US)

(21) Appl. No.: 13/301,054

(22) Filed: Nov. 21, 2011

Related U.S. Application Data
(63) Continuation-in-part of application No. 11/845,233, filed on Aug. 27, 2007, now abandoned.

(51) Int. Cl. A23P 1/00; B26D 7/06; A23L 1/212

(52) U.S. Cl. 426/518; 83/435

(57) ABSTRACT

An Avocado Cutting and Splitting Device. The device uses a single cutting blade to cut through both the seed and meat of incoming avocados. In order to increase uptime, the device had a feature that allows for the cutting blade to be sharpened while in operating condition (without the need for removing the blade from the machine). To increase the uniformity in the orientation of the cut in the avocados, there are a series of guides, elements and other apparatus that will place the incoming avocados in a consistent orientation relative to the cutting blade before they are cut. In order to improve throughput and reduce the need for human operator involvement, the device includes a set of custom-shaped ramps designed to guide and transport the cut avocado halves down to the moving exit conveyor so that the halves land face-down on the exit conveyor.

This application is a continuation-in-part of application Ser. No. 11/845,233, filed Aug. 27, 2007 (the “parent application”), now pending.

### BACKGROUND OF THE INVENTION

1. Field of the Invention

This invention relates generally to food processing equipment and, more specifically, to an Avocado Cutting and Splitting Device.

2. Description of Related Art

This present invention relates to an improvement in cutting avocados through the seed and meat such that the cut avocado exits in two sections to facilitate later seed and skin removal.

Avocados have become more and more popular for their versatility and arguable health-related benefits. They come in various varieties and sizes. For example, West Indian avocados produce enormous, smooth round, glossy green fruits that are low in oil and can weigh up to two pounds. Guatemalan varieties produce medium ovoid or pear-shaped, pebbled green fruits that turn blackish-green when ripe. The fruit or pulp of Mexican versions of avocado tends to be smaller (six to ten ounces) with skins that turn glossy green or black when ripe.

The pulp of avocados is deep green near the skin, becoming yellowish nearer the single large, inedible ovoid seed. The pulp is hard when harvested but softens to a buttery texture as the avocado ripens. Avocados are high in monosaturates and the oil content is second only to olives among fruits in its health benefits. Clinical feeding studies in humans have shown that avocado oil can actually reduce blood cholesterol.

To effectively obtain the pulp of an avocado, the avocado must be de-skinned and the seed must be removed. The device of the present disclosure addresses the process for preparing the fruit for later efficient seed and skin removal.

In the prior manual systems, an avocado is first cut through the seed. Thereafter the avocado is split into two sections. Generally one-half of the split avocado seed remains in each section. The seed from each half section would generally be removed before the avocado enters the de-skinning stage.

Typically, a worker would manually remove the avocado seed from each split section by using a spoon, or similar device, or their thumb. The spoon or thumb is pressed under the seed and the seed is then pried out. This can be a tedious and labor intensive job. Because of their popularity and continued growing popularity, and commercialization of avocados, a need exists to effectively and efficiently cut and split an avocado to facilitate removal of the seed.

The Parent Application disclosed a revolutionary method for cutting the avocado fruit in half without cutting through the internal seed. While that approach was much more successful than the prior manual (and rudimentary automated) systems, the variability in fruit size and ripeness tended to result in inconsistent output quality. As

The objects of the device of the present disclosure are to:
a. effectively and efficiently cut an avocado through both the seed and meat in a single pass;
b. automatically position the cut avocado-halves cut-side-down on an exit conveyor belt for later seed and skin removal without human intervention; and
c. stagger the cut avocado halves in spaced interval on the exit conveyor belt in a form that is most efficient and effective for the subsequent automated de-seeding/de-skinning process.

Many prior art devices provide for cutting of fruits to or through the seed and some split the fruit. These prior art devices are extremely complex, somewhat cumbersome, and costly to manufacture and maintain. None is as simple and as effective as the presently described device.

The foregoing has outlined some of the more pertinent objects of the device of the present disclosure. These objects should be construed to be merely illustrative of some of the more prominent features and applications of the device of the present disclosure. Many other beneficial results can be attained by applying the disclosed device of the present disclosure in a different manner or by modifying the device of the present disclosure within the scope of the disclosure. Accordingly, other objects and a fuller understanding of the device of the present disclosure may be had by referring to the summary of the device of the present disclosure and the detailed description of the preferred embodiment in addition to the scope of the device of the present disclosure defined by the claims taken in conjunction with the accompanying drawings.

### SUMMARY OF THE INVENTION

In light of the aforementioned problems associated with the prior devices and systems, it is an object of the present invention to provide an Avocado Cutting and Splitting Device. The device of the present invention should use a single cutting blade to cut through both the seed and meat of incoming avocados. In order to increase uptime, the device should provide a feature that allows for the cutting blade to be sharpened while in operating condition (without the need for removing the blade from the machine). To increase the uniformity in the orientation of the cut in the avocados, there should be a series of guides, elements and other apparatus that will place the incoming avocados in a consistent orientation relative to the cutting blade before they are cut. In order to improve throughput and reduce the need for human operator involvement, the device should include a set of custom-shaped ramps designed to guide and transport the cut avocado halves down to the moving exit conveyor so that the halves land face-down on the exit conveyor.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the device of the present invention;

FIG. 2 is a perspective view of the device of FIG. 1 having the blade shield lifted;

FIG. 3 is a partial perspective view of the device of FIGS. 1 and 2;

FIG. 4 is a front view of the device of FIGS. 1-3;

FIG. 5 is a front view of the device of FIGS. 1-4 depicting the cutting of an avocado;

FIG. 6 is a side view of the device of FIGS. 1-5; and

FIG. 7 is a rear perspective view of the device of FIGS. 1-6.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an Avocado Cutting and Splitting Device.

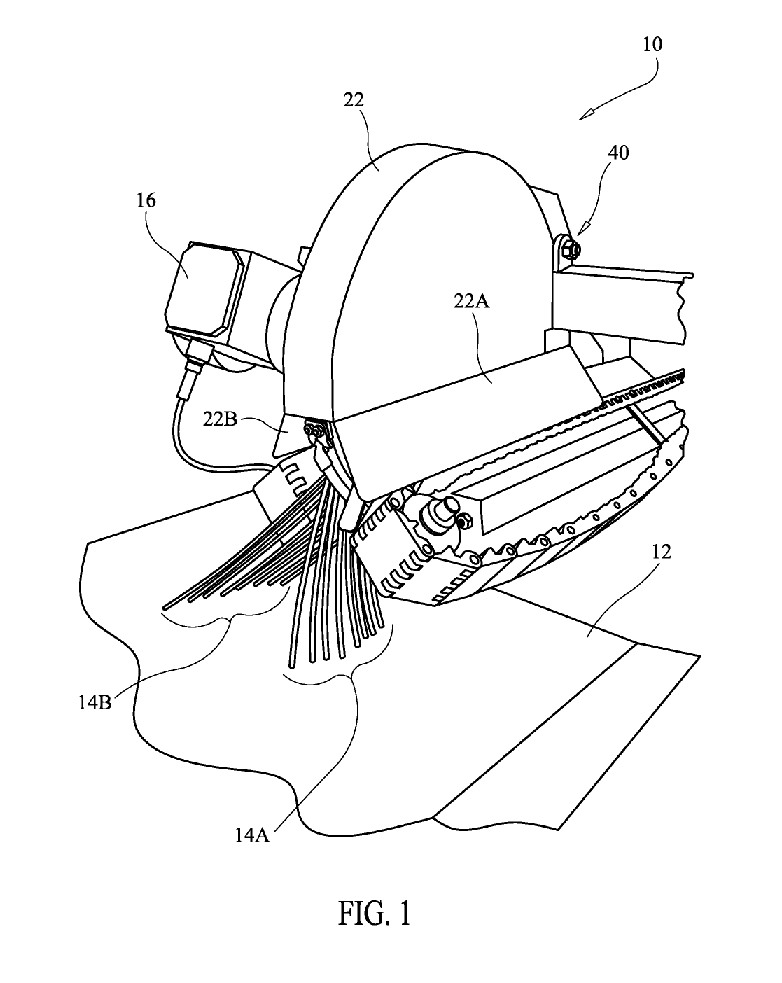

The present invention can best be understood by initial consideration of FIG. 1. FIG. 1 is a perspective view of a preferred embodiment of the device 10 of the present invention. The avocado cutting and splitting device 10, as contrasted with the device that is the subject of the parent application, has only a single cutting blade. The single blade serves to simply cut the individual avocados in two separate pieces, with each piece having not only one-half of the fruit, but also of the seed. The resultant simplification of the device 10 allows for more reliable, versatile production of split avocados, in virtually all stages of ripeness.

While in operation, the blade (not shown) is covered by blade shield 22 in order to protect the operators and to prevent spray or splatter of avocado parts during the cutting process. The bottom portions (right and left sides) of the shield 22 are bent to cant outwardly to form the first and second shield skirts 22A, 22B. The shield skirts 22A, 22B provide protection next to and above the cutting area of the blade (not shown) so that the entire cutting area is securely covered, including above and around the incoming and outgoing avocados (as will become apparent with the discussion below in connection with other drawing figures).

In its preferred form, the device 10 is driven by a single motor 16 driving a shaft (not shown) to rotate. As can be seen, the shaft (not shown) in the depicted version only extends from a single side of the cutting blade (not shown).

Avocados that have been cut and split in two parts will exit the device 10 via the moving exit conveyor belt 12. In most instances, the exit conveyor belt 12 will transport the split avocados to a suitable avocado “pulping and skinning” machine where the seeds and skins will be removed and discarded from the fruit (pulp) of the avocado. An example of such a device that was designed to work cooperatively with the device of the parent application is disclosed in U.S. patent application Ser. Nos. 12/423,356 and 12/628,806.

The split avocados slide from the cutting area to the exit conveyor belt 12 along the first and second finger ramps 14A, 14B. These ramps 14A, 14B are preferably made from individual stainless steel rods that are curved so as to form the overall complex curved shape that is shown. Furthermore, the rod design creates low friction so that the fruit slides easily, are easy to clean, and the operators can actually see through the ramps 14A, 14B while the device 10 is in operation.

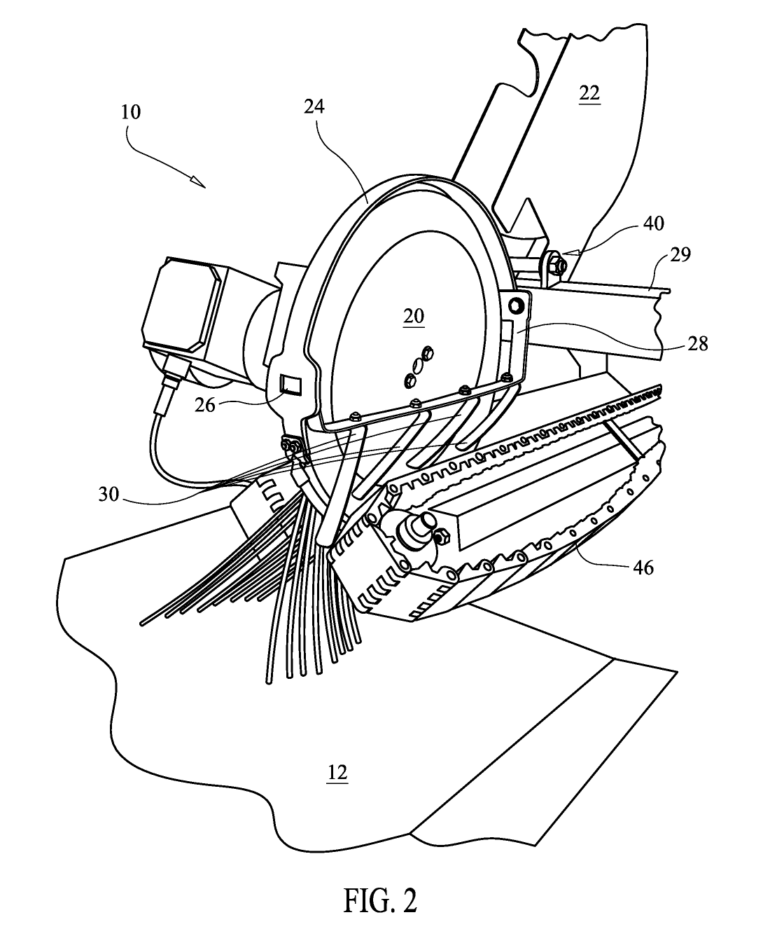

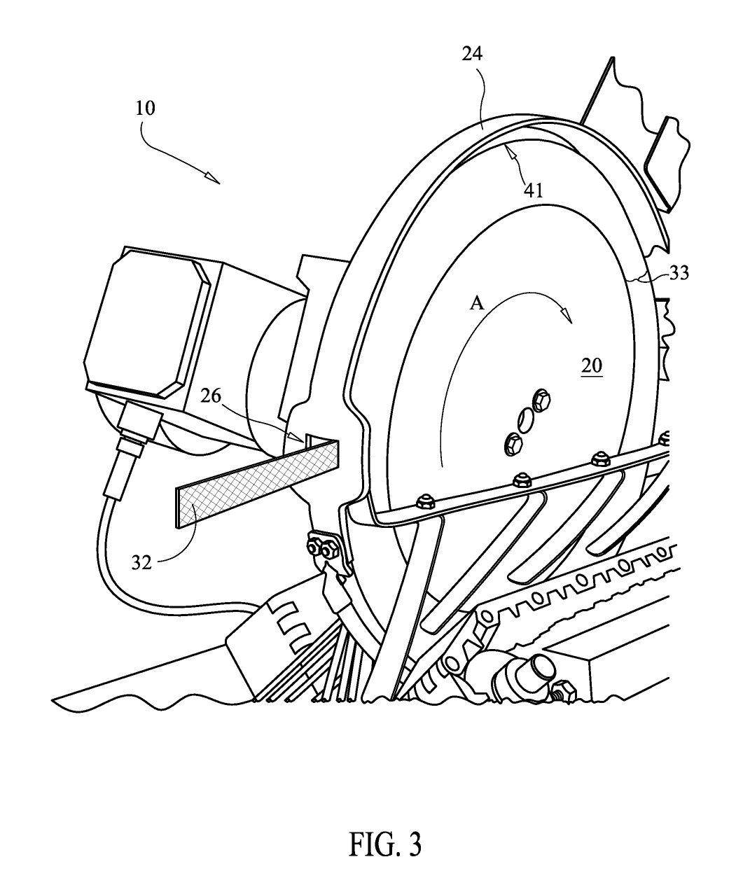

The blade shield 22 is hingably attached to the device 10 at hinge axle 40 so that it may be lifted up and out of the way as depicted in FIG. 2. FIG. 2 is a perspective view of the device 10 of FIG. 1 having the blade shield 22 lifted. With the shield 22 lifted, we can now see the cutting blade 20, as well as other elements of this novel design. An upper blade frame 24 generally encircles the upper arc of the cutting blade 20 in order to serve at least three functions: (1) it protects the operators from the sharp cutting blade in the event that the shield 22 must be lifted up while the device 10 is in operation; (2) it serves as a base or mounting point for other structural elements of the device 10; and (3) it provides a stable structure upon which an operator can rest a sharpening implement (as will be discussed more fully below in connection with FIG. 3).

The upper blade frame 24 has a sharpening window formed in its front side that permits the operator access to the cutting edge of the blade 20 for sharpening (see FIG. 3, below).

A lower blade frame 28 attaches to the upper blade frame 24 and/or the main frame 29 of the device 10. The frame 28 extends from the rear side of the blade 20 and around the two sides of the blade 20 until it interconnects to the upper blade frame 24 in front of the blade 20, just below the sharpening window 26. A series of biasing elements 30 extend downwardly from the two blade-side sections of the lower blade frame 28. These biasing elements 30 are made from spring-grade stainless steel and are configured to provide gentle downward pressure on the incoming and outgoing avocados during the cutting process. The downward pressure provided by the elements 30 will tend to keep the split avocados tight against the two conveyor belts 46 until the split pieces drop off of the end of the conveyor belts 46 and then the elements 30 urge the cut pieces to drop down the elements of the ramp fingers (see FIG. 1) with the interior cut face of the avocado facing the ramp fingers (see FIG. 1).

The conveyor belt 46 and exit conveyor 12 are preferably made from Urethane, PTFE or other plastic material, while virtually all other components of the device 10 that may come in contact with food product would preferably be made from stainless steel. Now turning to FIG. 3, we can examine another unique feature of the instant design.

FIG. 3 is a partial perspective view of the device 10 of FIGS. 1 and 2. This view is presented to explain the novel blade sharpening process introduced by this invention. Historically, the cutting blade would be removed in order to sharpen the blade on a machine such as this. Of course, this is an undesirable interruption in production, and therefore a new approach was needed. In the current design for the device 10, the blade 20 can be sharpened in-situ, without blade removal. The operator needs to simply clean the machine 10 and the activate the blade (which rotates in direction “A”). Once the blade 20 has reached normal rotational speed, the operator inserts a conventional sharpening stone 32 through the sharpening window 26 until it comes in contact with the blade 20. As shown here, the sharpening stone 32 is held so that the abrasive face is aligned against the beveled section 33 of the blade 20—here the near-side beveled section 33 is being ground down. After a short period of time, the sharpening stone 32 is removed and reinserted so that it is aligned against the far-side beveled section 33. This process is repeated for the two sides until a suitably sharp cutting edge 41 is produced on the blade 20. After a brief wipe-down, the device 10 can be placed back in service. Because of the ease of sharpening using the sharpening window 26, it is expected that the blade 20 will be regularly maintained in a condition that is sharper than was previously convenient.

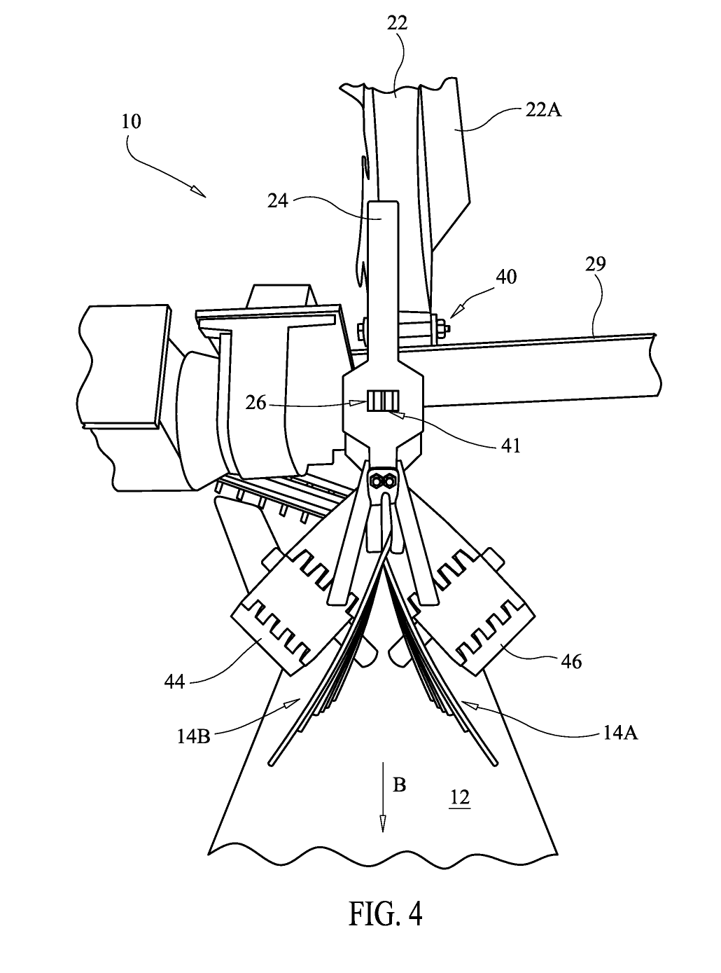

FIG. 4 is a front view of the device 10 of FIGS. 1-3. As can be seen here, the conveyor belts 44 and 46 are arranged on either side of the cutting blade so as to form a “V” to cradle the incoming uncut avocados. The belts 44, 46 move synchronously in order to drive the individual avocados into the back-side of the cutting blade. After being cut, the avocado halves continue to travel on the tops of the conveyor belts 44, 46 until they drop off the ends (can be seen in FIGS. 1 and 2) and land on the exit conveyor belt 12. As discussed previously, the cut avocados will land face-down on the first and second finger ramps 14A, 14B as they drop off the ends of the conveyor belts 44, 46, and gravity (with assistance from the shape of the ramps 14A, 14B) will cause the avocado halves to land face-down on the exit conveyor belt 12. The belt 12 is moving in direction “B” to transport the avocado-halves to the next stage of the avocado pulping operation, where the avocado meat is removed from the seeds and skins.

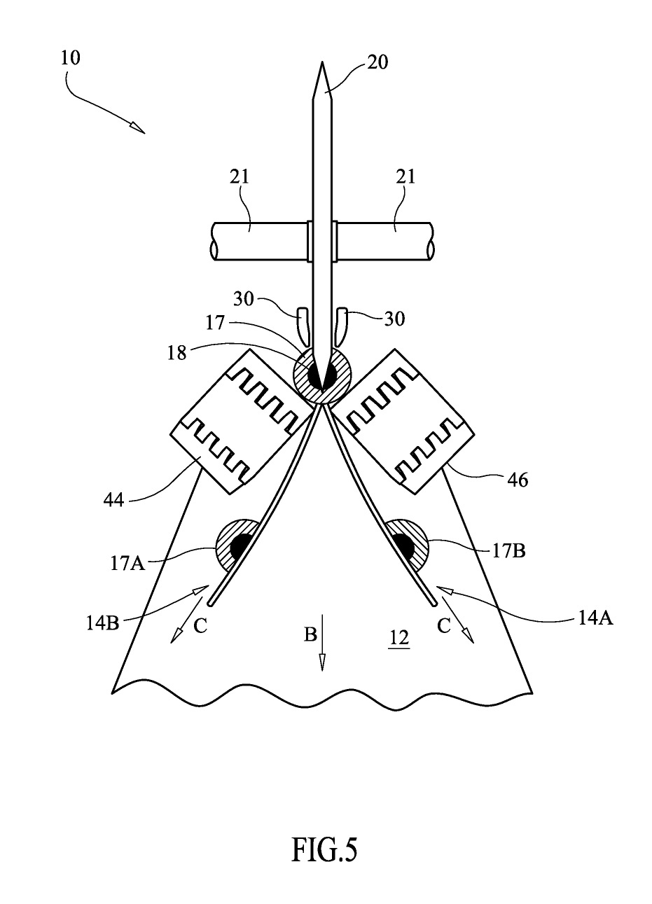

FIG. 5 is a simplified depiction of the front view of the device 10 of FIGS. 1-4 depicting the cutting of an avocado (as viewed when facing the machine from directly in front). The biasing elements 30 (of which only the final pair is shown here), press down on the avocado 17 so that it is firmly within the “V” made by the two moving conveyor belts 44, 46. As the belts 44, 46 carry the avocado 17 past the cutting blade 20, the entire avocado 17 and seed 18 are cut into two virtually matching pieces. Each half 17A, 17B is directed by the upper ends of the finger ramps 14A, 14B so that they separately travel down their respective ramp 14A, 14B in direction “C”. As they land on the exit conveyor 12, they will be carried away face-down in direction “B”.

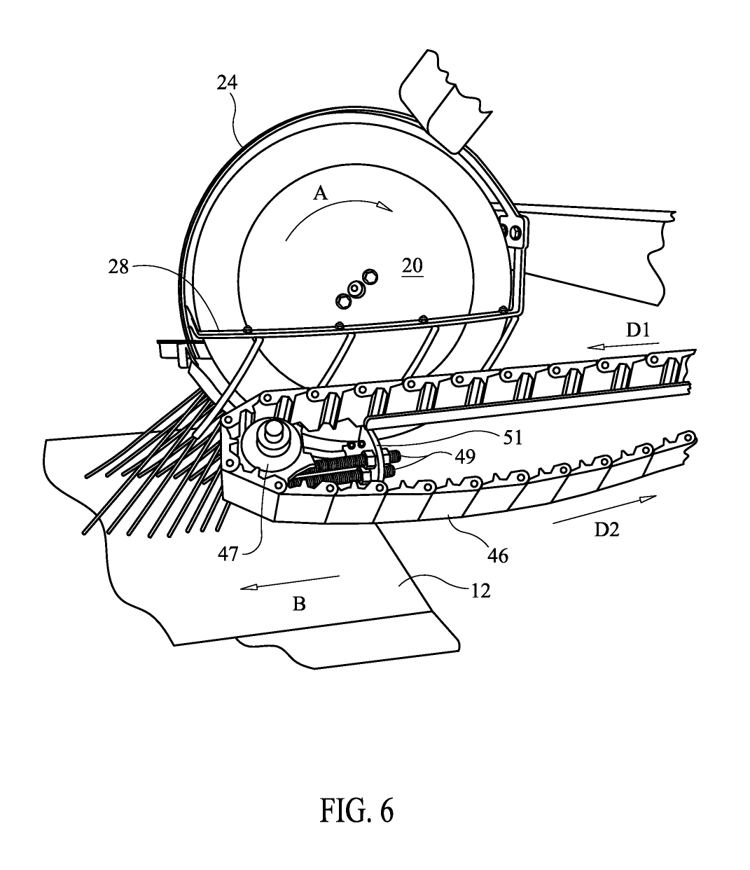

Although not depicted here, another feature of the device 10 of the present invention is a guide member that is positioned so that it “floats” above the surface of the exit conveyor 12 and acts to direct incoming avocado-halves 17A, 17B into a single-file line centered on the conveyor belt 12. The guide member is formed from a pair of opposing flat members arranged to create a V-shaped funnel slightly above the upper surface of the exit conveyor belt 12. FIG. 6 is provided to clarify the direction of movement of the various moving components of the device 10. The conveyor belt 46 (and 44) travel in a loop at both ends, with the front end being idler spindle 47 (the drive spindle is at the opposing end of the loop). The spindle 47 is attached to tensioner bracket 51, which extends from the main frame of the device. One or more tensioner bolts 49 are provided to allow the operators to increase or decrease the distance between ends of the loop (i.e. between the idler and drive spindles) until the desired conveyor belt tension is obtain. Adjustment of the tensioner bolts is an important convenience to account for wear of the conveyor belts and/or the need to remove the belts for maintenance.

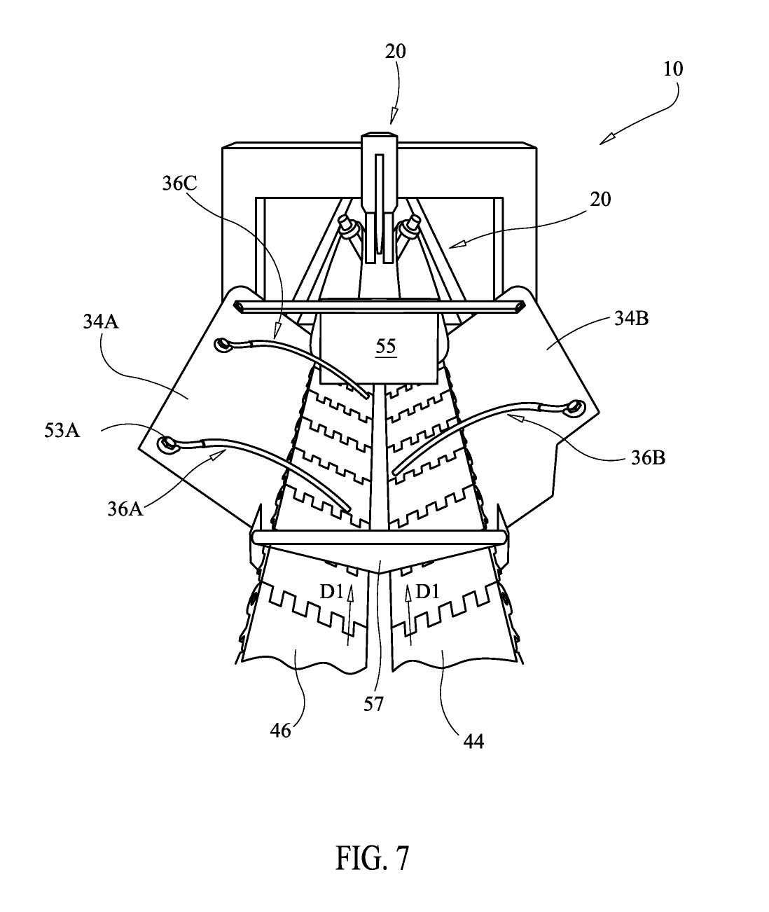

The upper surface of the conveyor belt 46 moves in direction D1 to feed whole avocados into the cutting blade 20 (the bottom surface of the belt 46 moves in direction D2. The blade 20 is rotating clockwise in this view such that the bottom outer edge of the blade 20 is also moving in direction D1. The blade 20 rotates so that its cutting edge (at the bottom of the blade 20 in this depiction) is moving away from the incoming whole avocados (in the same direction as D1); this tends to pull the avocados through the blade and propel them down the finger ramps to the belt 46. As discussed in connection with prior drawing figures, the exit conveyor belt 12 moves away from the cutting blade in direction B. We will finally turn to FIG. 7 to examine the operation of the device 10 at the pre-cut stage (feed) stage.

FIG. 7 is a rear perspective view of the device 10 of FIGS. 1-6. The conveyor belts 44, 46 feed whole avocados towards the cutting blade (indicated by arrow 20). End guard 57 is a stationary element that is positioned over the top of the conveyor belts 44, 46 in order to knock down any piles of whole avocados and to prevent them from accidentally falling out through the back of the conveyor belts 44, 46 (i.e. the end closest to the reader). A second element, the feed flap 55 is made from flexible, rubberized material, and is positioned at the distal end of the feed stage, just before the cutting blade components—its purpose is to gently re-position the incoming avocados so that they are aligned on their “side” before being cut. On its side in this circumstance means that the pointed end of the avocado is either pointed towards or pointed away from the cutting blade (rather than being pointed up, down or sideways). This insures that each avocado is cut lengthwise, without the need for additional operator intervention in most cases.

First and second feed support members 34A, 34B are positioned above and outside the moving conveyor belts 44, 46, and function as a stable mounting point for feed fingers 36A, 36B, 36C, and of course to guide the individual avocados down to the conveyor belts 44, 46. The fingers 36A-36C are flexible pieces of metal having a plastic or other pliable protective coating. The fingers 36A-36C can flex as whole avocados are drawn down the moving valley created by the conveyor belts 44, 46, so that they gently guide the avocados to rest securely in the lowest portion of the valley in preparation for cutting. Each finger 36A-36C is attached to the feed support members 34A, 34B by a variety of means, including the bolts (e.g. 53A) shown here.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed:

1. An avocado cutter comprising:
a rotatable blade with an engaging section to be rotating in a direction D1; and
a pair of parallel, movable conveyor belts, each said belt forming a closed loop terminating at a drive spindle and a idler spindle, said belts each defining a substantially flat upper surface, with said belts cooperatively positioned to form a V shaped valley therebetween passing beneath said rotatable blade in direction D1.

2. The cutter of claim 1, further comprising:
a main frame to which said blade, belts and spindles attach; and
an upper blade frame having an arcuate shape, and designed to cooperate with the circular peripheral cutting edge formed on said blade, whereby said upper blade frame encircles said peripheral cutting edge in spaced relation thereto.

3. The cutter of claim 2, wherein said upper blade frame is further defined by an opening formed therethrough juxtaposed over a section of said peripheral cutting edge.

4. The cutter of claim 3, further comprising first and second lower blade frame members extending alongside and in relative spaced relation to opposite non-cutting sides of said blade, each said lower blade frame positioned over a portion of each of said parallel conveyor belts.

5. The cutter of claim 4, further comprising a plurality of biasing elements attached in relative spaced relation along said lower blade frame members, said biasing elements oriented to generate biasing forces towards said upper surfaces of said parallel conveyor belts.

6. The cutter of claim 5, further comprising first and second ramp assemblies, said ramp assemblies configured to direct items dropping ends of said parallel conveyor belts onto an exit conveyor belt.

7. The cutter of claim 6, wherein said first and second ramp assemblies are defined by upper edges and lower edges, said lower edges positioned in close proximity to said exit conveyor belt and said upper edges positioned between said parallel conveyor belts.

8. The cutter of claim 7, wherein said first and second ramp assemblies are defined by a plurality of individual elongate fingers extending between said upper edges and said lower edges.

9. A device for cutting generally spherical objects into two pieces, comprising:
a rotatable blade with an engaging section to be rotating in a direction D1;
a pair of parallel, movable conveyor belts, each said belt forming a closed loop terminating at a drive spindle located in back of said rotatable blade and an idler spindle located in front of said rotatable blade, said belts each defining a substantially flat upper surface, with said belts cooperatively positioned to form a V shaped valley therebetween passing beneath said rotatable blade in direction D1; and
first and second stationary feed support members extending upwardly and outwardly from said movable conveyor belts at a location between said drive spindles and said rotatable blade.

10. The device of claim 9, further comprising a plurality of elongate feed fingers extending downwardly from said feed support members to each terminate in a distal end above said conveyor belts.

11. The device of claim 10, further comprising a flexible feed flap extending downwardly from a position above said movable conveyor belts at a location between said drive spindles and said rotatable blade.

12. The device of claim 11, further comprising first and second lower blade frame members extending alongside and in relative spaced relation to opposite non-cutting sides of said blade, each said lower blade frame positioned over a portion of each of said parallel conveyor belts.

13. The device of claim 12, further comprising a plurality of biasing elements attached in relative spaced relation along said lower blade frame members, said biasing elements oriented to generate biasing forces towards said upper surfaces of said parallel conveyor belts.

14. The device of claim 13, further comprising:
a main frame to which said blade, belts and spindles attach; and
an upper blade frame having an arcuate shape, and designed to cooperate with the circular peripheral cutting edge formed on said blade, whereby said upper blade frame encircles said peripheral cutting edge in spaced relation thereto.

15. The device of claim 14, further comprising first and second ramp assemblies, said ramp assemblies configured to direct items dropping ends of said parallel conveyor belts onto an exit conveyor belt.

16. The device of claim 15 of claim 7, wherein said first and second ramp assemblies are defined by a plurality of individual elongate fingers extending between said upper edges and said lower edges.

17. The device of claim 16, wherein said upper blade frame is further defined by an opening formed therethrough juxtaposed over a section of said peripheral cutting edge.

18. The device of claim 17, wherein said first and second ramp assemblies are defined by upper edges and lower edges, said lower edges positioned in close proximity to said exit conveyor belt and said upper edges positioned between said parallel conveyor belts.

19. A method for splitting avocados into two pieces, comprising the steps of:
placing a whole avocado into a V-shaped gap between a pair of generally parallel moving conveyor belts;
transporting said whole avocado along said conveyor belts to a cutting area;
cutting said whole avocado completely through by a circular blade rotating such that the lower edge of said blade is moving in the same linear direction as said conveyor belts;
guiding each individual half of said cut avocado to each slide down a curved ramp formed from a plurality of elongate fingers to a moving exit conveyor belt; and
transporting said cut halves away from said circular blade on said exit conveyor belt.

20. The method of claim 19, further comprising the step of holding down said whole avocado during said cutting step, said holding down step comprising a plurality of biasing elements extending downwardly from opposite sides of said circular blade.
